(19) United States
(12) Patent Application Publication
(10) Pub. No.: US 2009/0249561 A1
(43) Pub. Date: Oct. 8, 2009

(54) Kit of Parts Comprising a Solid Laundry Detergent Composition and a Dosing Device

(76) Inventor: Alan Thomas Brooker, Newcastle (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/413,726

(22) Filed: Mar. 30, 2009

(30) Foreign Application Priority Data
Apr. 2, 2008 (EP) 08006708.5

(51) Int. Cl. C11D 3/40; C11D 3/386; D06F 35/00

(52) U.S. Cl. 8/159; 510/276; 510/320

(57) ABSTRACT

The present invention relates to a kit of parts for treating fabric in an automatic washing machine, the kit of parts comprising: (a) a solid laundry detergent composition comprising a reactive dye; and (b) a dosing device that is capable of being placed in the drum of the automatic washing machine.

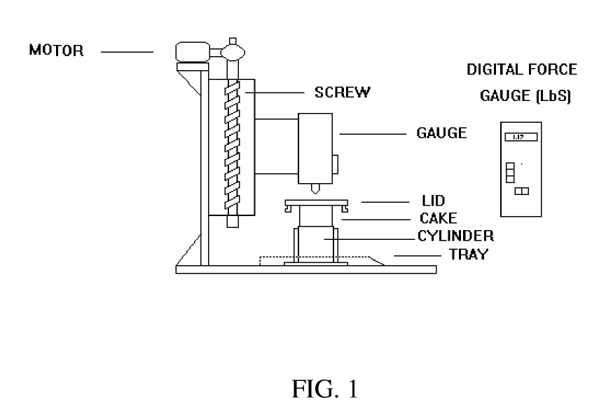

### FIELD OF THE INVENTION

The present invention relates to a kit of parts comprising a laundry detergent composition and a dosing device. The laundry detergent composition is capable of dyeing fabric and cleaning fabric during a laundering process. The laundry detergent composition is in solid form and comprises a reactive dye. The dosing device is capable of being placed in the drum of an automatic washing machine.

### BACKGROUND OF THE INVENTION

Laundry detergent manufacturers have attempted to meet the consumer need to rejuvenate coloured fabrics and provide good fabric-cleaning performance during the laundering process. Current fabric treatment compositions that comprise fabric-substantive dyes do not adequately clean the fabric during the laundering process, and the consumer still needs to use additional conventional laundry detergent compositions (i.e. that do not comprise fabric-substantive dyes) in order to adequately clean the fabric. However, this combination is costly and not efficient as two separate laundering processes need to be undertaken. Furthermore, previous attempts by the detergent manufacturers to provide a detergent composition that provides a good colour-rejuvenation profile have focused on dyes that are used to dye fabrics during textile mill processes, and to incorporate these dyes into laundry detergent compositions. However, these dyes are not as fabric substantive during the laundering process when relatively low temperatures (from 5° C. to 60° C.) typical of domestic laundering processes are used compared to the textile mill process when relatively higher temperatures (90° C. to 95° C.) typical of textile mill processing conditions are used. Simply incorporating these dyes into conventional laundry detergent compositions leads to inefficient colour rejuvenation profile.

Furthermore, over multiple wash cycles, the colour of fabrics laundered with conventional laundry detergent compositions deteriorates to an undesirable degree. There continues to be a need to provide a laundry detergent composition that provides good colour care, colour rejuvenation and a good cleaning performance.

In addition, laundry detergent compositions that comprise reactive dyes are difficult and messy for the consumer to handle during the laundering process. The reactive dye may come into contact with, and undesirably colour, surfaces other than the intended fabrics to be so treated, such as the consumer's skin and their clothing.

The Inventors have improved the efficiency of the fabric treatment and improved the consumer experience of using laundry detergent compositions that comprise reactive dyes by providing a kit of parts as defined in claim 1.

### SUMMARY OF THE INVENTION

The present invention relates to a kit of parts as defined in claim 1.

### DETAILED DESCRIPTION OF THE INVENTION

### Solid Laundry Detergent Composition.

The solid laundry detergent composition comprises a reactive dye and typically comprises a detersive surfactant. The detersive surfactant and reactive dye are discussed in more detail below.

Upon contact with water the composition typically has an equilibrium pH of 10.5 or greater at a concentration of 4 g/l in de-ionized water and at a temperature of 20° C. The pH profile of the composition is discussed in more detail below.

Preferably, the composition comprises an alkalinity source. The alkalinity source is discussed in more detail below.

Preferably, the composition comprises less than 5 wt %, or less than 4 wt %, or less than 3 wt %, or less than 2 wt %, or less than 1 wt % anionic detersive surfactant. Preferably, the composition is essentially free of anionic detersive surfactant. By “essentially free of” it is typically meant “no deliberately added”. Reducing the level of, and even removing, the anionic detersive surfactant improves the colour-rejuvenation profile of the composition.

Preferably, the composition comprises less than 5 wt %, or less than 4 wt %, or less than 3 wt %, or less than 2 wt %, or less than 1 wt % sodium sulphate. Preferably, the composition is essentially free of sodium sulphate. By “essentially free of” it is typically meant “no deliberately added”. Reducing the level of, and even removing, sodium sulphate chemically compacts the composition; and thus improving its transport efficiency, improving its shelf-storage efficiency, and further improving its environmental profile.

Preferably, the composition comprises less than 5 wt %, or less than 4 wt %, or less than 3 wt %, or less than 2 wt %, or less than 1 wt % bleach. Preferably, the composition is essentially free of bleach. By “essentially free of” it is typically meant “no deliberately added”. Reducing, and even removing, bleach improves the colour rejuvenation profile of the composition.

Preferably, the composition comprises less than 10 wt %, or less than 5 wt %, or less than 4 wt %, or less than 3 wt %, or less than 2 wt %, or less than 1 wt % phosphate builder. Preferably, the composition is essentially free of phosphate builder. By “essentially free of” it is typically meant “no deliberately added”. Reducing, and even removing, phosphate builder further improves the environmental profile of the composition.

Preferably, the composition comprises less than 10 wt %, or less than 5 wt %, or less than 4 wt %, or less than 3 wt %, or less than 2 wt %, or less than 1 wt % zeolite builder. Preferably, the composition is essentially free of zeolite builder. By “essentially free of” it is typically meant “no deliberately added”. Reducing, and even removing, zeolite builder from the composition improves its dissolution profile.

Preferably, the composition comprises less than 10 wt %, or less than 5 wt %, or less than 4 wt %, or less than 3 wt %, or less than 2 wt %, or less than 1 wt % sodium silicate. Preferably, the composition is essentially free of sodium silicate. By “essentially free of” it is typically meant “no deliberately added”. Reducing, and even removing, sodium silicate from the composition improves its dissolution profile.

Preferably, the composition comprises an enzyme system. The enzyme system is described in more detail below.

### Detersive Surfactant.

The composition typically comprises a detersive surfactant. Suitable detersive surfactants are selected from non-ionic detersive surfactant, anionic detersive surfactant, cationic detersive surfactant, zwitterionic surfactant, or any mixture thereof. However, as discussed in more detail above, preferably the composition comprises a low level of, or is even essentially free of, anionic detersive surfactant.

The composition preferably comprises non-ionic detersive surfactant. This is especially preferred when the composition comprises low levels of, or is essentially free of, anionic detersive surfactant. Preferably, the non-ionic detersive surfactant comprises a C₈-C₂₄ alkyl alkoxylated alcohol having an average degree of alkoxylation of from 1 to 20, preferably a C₁₀-C₁₈ alkyl alkoxylated alcohol having an average degree of alkoxylation of from 1 to 10, or even a C₁₂-C₁₈ alkyl alkoxylated alcohol having an average degree of alkoxylation of from 1 to 7. Preferably, the non-ionic detersive surfactant is an ethoxylated alcohol. Preferably, the non-ionic surfactant comprises an alkyl polyglucoside. The non-ionic detersive surfactant may even be a predominantly C₁₆ alkyl ethoxylated alcohol having an average degree of ethoxylation of from 3 to 7.

Preferably, the non-ionic detersive surfactant is in particulate form, and wherein the particle has a cake strength of from 0 kg to 1.5 kg. The method to determine cake strength is described in more detail below.

### Method to Determine the Cake Strength

The cake strength is typically determined by the following method:

### Apparatus

### Cake Former

The cake formation apparatus is designed to produce a cylindrical cake of 6.35 cm in diameter and 5.75 cm in height.

| | |
|---|---|
| CYLINDER | Solid perspex, with polished surface. |
| | Diameter 6.35 cm |
| | Length 15.90 cm |
| | Base plate on end, diameter 11.40 cm, depth 0.65 cm |
| | 0.65 cm hole through the cylinder, with its centre 9.2 |
| | cm from the end opposite the base plate |
| SLEEVE | Hollow perspex, with polished inner surface |
| | Inner diameter 6.35 cm |
| | Wall thickness 1.50 cm |
| | Length 15.25 cm |
| LID | Perspex disc |
| | Diameter 11.5 cm |
| | Thickness 0.65 cm |
| LOCKING PIN | Stainless steel |
| | Diameter 0.6 cm |
| | Length 10 cm |
| WEIGHTS | 5 Kg to fit size of lid |
| | 10 kg, to fit size of lid |
| Force Recorder | |
| FORCE GAUGE | Either manual or electronic: battery/mains operated |
| | Max capacity 25 kg |
| | Graduations 0.01 kg |
| MOTORISED | Solid stand |
| STAND | Force gauge mounted on a block which moves in a |
| | vertical direction on a screw, driven by a reversible |
| | motor Rate of gauge descent = 54 cm/min |
| POWDER TRAY | For collection of powder from broken cake |
| STEEL RULE | For smoothing top of cake |

### Equipment Set-Up

SEE ATTACHED DRAWING.

### Test Conditions

Conditioning: powder samples should be stored at 35° C. for 24 hrs before testing. Test equipment should also be at 35° C.

### Procedure

### Step by Step Procedure

1> Place cake formation cylinder on a flat surface
2> Place the locking pin in the hole.
3> Slip on the cake formation sleeve and check that it moves freely
4> Pour in representative test material sample until the material overflows the cylinder sides
5> Level off granules with one smooth action using a steel rule or equivalent straight edge.
6> Place top plate on cylinder and centre by eye.
7> Place weight on top of assembly
8> Carefully, gently remove the restraining rod and start timer
9> Whilst cake is being formed move force meter to top position and zero it.
10> After two minutes, remove weight
11> Slide down cylinder so cake is completely exposed (leaving top plate remaining).
12> Gently place cake formation assembly under force meter
13> Centre assembly under force gauge by eye.
14> Start force meter apparatus so that it descends and breaks cake.
15> Read the maximum force (in Kgs) required to break the cake from the force meter dial.
16> Repeat least three times for each material and average the forces, this average is the mean cake strength for the material tested.

### Reactive Dye.

The composition comprises a fabric-substantive dye, preferably a reactive dye. Preferably, the dye is a reactive azo dye. Preferably, the composition comprises a black and/or blue reactive dye, although other reactive dyes such as red, orange and/or yellow reactive azo dyes may also be present.

The reactive dye preferably has the structural formula:

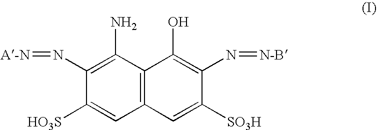

wherein A′ and B′ are each independent selected from an aromatic group which is unsubstituted or substituted by halogen, C₁-C₄ alkyl, C₁-C₄ alkoxyl, sulphonyl, or amino groups. Preferably, the reactive dye has the structural formula:

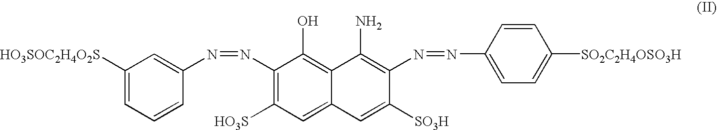

Suitable reactive dyes are described in more detail in U.S. Pat. No. 6,126,700.

Typically, the reactive dye comprises an anionic moiety, such as a sulphonyl moiety bound to the substituted naphthalene. However, for convenience, the above formulae show the reactive dye in their free acid form. Furthermore, the reactive dye is typically in the form of a salt, especially an alkali metal salt, such as sodium salt or potassium salt, or the salt can be in the form of an ammonium salt.

The reactive dye preferably comprises: (a) a black reactive dye having the above formula II; and (b) at least one other black or blue reactive dye having the above formula I, and preferably (c) at least one other red, orange and/or yellow reactive azo dye. The above described reactive dye that comprises components (a), (b) and (c) has an excellent dye build-up profile on the fabric during the laundering process. Preferably, the black reactive dye (component (a)) is the major component of the reactive dye.

Preferably the black or blue reactive dye of component (b) is a compound having one of the following formulae:

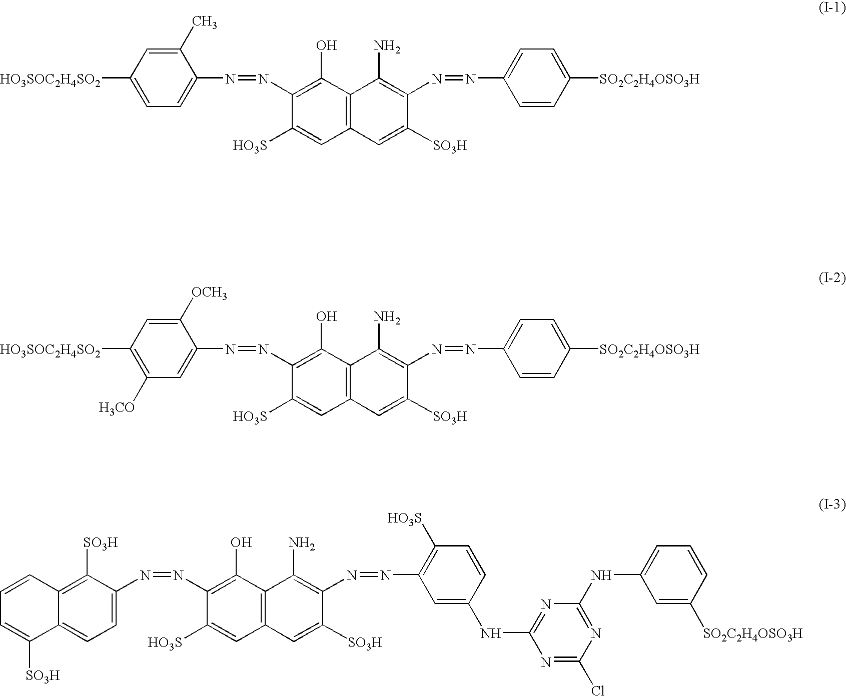

There is no special limitation on the red, orange or yellow reactive azo dye of component (c). Any red, orange and/or yellow reactive azo dyes can be used. More specific examples of component (c) are:

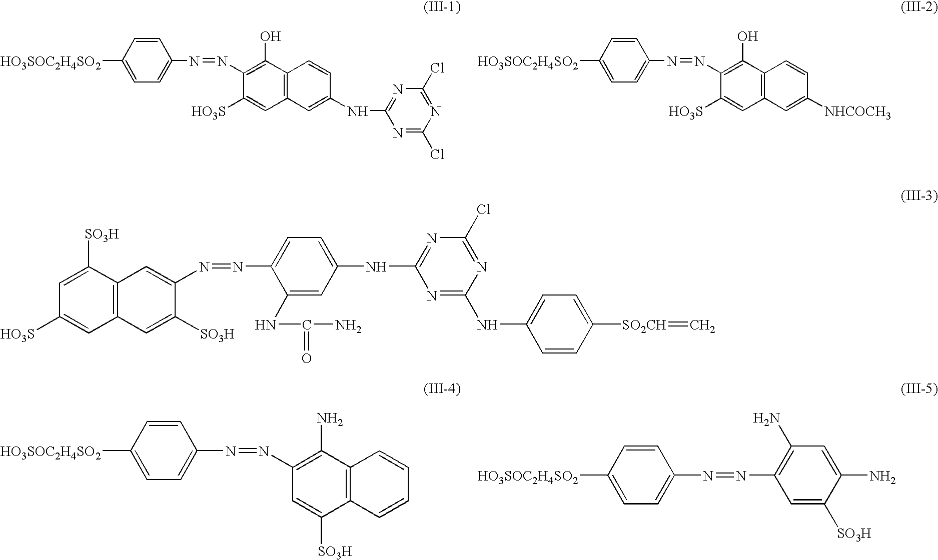

The weight ratio of the dye components (a), (b) and (c) may vary. However, typically, the reactive dye comprises at least 3 wt % component (a), at least 3 wt % component (b) and at least 3 wt % component (c). Preferably, the reactive dye comprises from 3 wt % to 90 wt % component (a). Examples of suitable reactive dyes are described in detail below. Formula is given in parenthesis, the number is the wt % of the component in the reactive dye.

| | Component (a) | Component (b) | Component | Component |
|---|---|---|---|---|
| Example | (%) | (%) | (c) (%) | (c) (%) |
| 1 | (II) 58 | (I-1) 20 | (III-2) 15 | (III-3) 7 |
| 2 | (II) 29 | (I-1) 61 | (III-1) 7 | (III-3) 3 |
| 3 | (II) 59 | (I-1) 21 | (III-2) 20 | 0 |
| 4 | (II) 28 | (I-1) 62 | (III-2) 10 | 0 |
| 5 | (II) 55 | (I-1) 16 | (III-4) 17 | (III-5) 12 |
| 6 | (II) 31 | (I-1) 52 | (III-4) 10 | (III-5) 7 |
| 7 | (II) 57 | (I-2) 22 | (III-1) 14 | (III-3) 7 |
| 8 | (II) 27 | (I-2) 63 | (III-1) 7 | (III-3) 3 |
| 9 | (II) 58 | (I-2) 23 | (III-2) 19 | 0 |
| 10 | (II) 27 | (I-2) 64 | (III-2) 9 | 0 |
| 11 | (II) 54 | (I-2) 17 | (III-4) 17 | (III-5) 12 |
| 12 | (II) 29 | (I-2) 55 | (III-4) 9 | (III-5) 7 |
| 13 | (II) 56 | (I-3) 23 | (III-1) 14 | (III-3) 7 |
| 14 | (II) 26 | (I-3) 64 | (III-1) 7 | (III-3) 3 |
| 15 | (II) 57 | (I-3) 24 | (III-2) 19 | 0 |
| 16 | (II) 26 | (I-3) 65 | (III-2) 9 | 0 |
| 17 | (II) 54 | (I-3) 17 | (III-4) 17 | (III-5) 12 |
| 18 | (II) 29 | (I-3) 56 | (III-4) 9 | (III-5) 6 |
| 19 | (II) 89 | (I-1) 11 | 0 | 0 |
| 20 | (II) 42 | (I-1) 58 | 0 | 0 |
| 21 | (II) 81 | (I-2) 19 | 0 | 0 |
| 22 | (II) 40 | (I-2) 60 | 0 | 0 |
| 23 | (II) 80 | (I-3) 20 | 0 | 0 |
| 24 | (II) 39 | (I-3) 61 | 0 | 0 |

pH.

Upon contact with water the composition typically has an equilibrium pH of 10.5 or greater at a concentration of 4 g/l in de-ionized water and at a temperature of 20° C. Preferably, upon contact with water the composition has an equilibrium pH in the range of from 10.5 to 12.0 at a concentration of 4 g/l in de-ionized water and at a temperature of 20° C. Preferably, upon contact with water the composition has an equilibrium pH of 11.0 or greater at a concentration of 4 g/l in de-ionized water and at a temperature of 20° C.

Without wishing to be bound by theory, it is believed that the high pH improves the strength of the dye-fabric interaction, improves the fabric-substantivity of reactive dye and improves the colour rejuvenation profile of the solid laundry detergent composition.

The method of determining the pH profile of the composition is described in more detail below.

### Method for Determining the pH Profile.

Dose 2.00 g of composition into a glass beaker and add 150 ml of de-ionised water at 20° C. Stir using a magnetic stirrer. Transfer the mixture from the beaker into a volumetric flask and make up to 500 ml with de-ionised water at 20° C. Mix well. Calibrate a pH meter using pH 7 and pH 10 buffers. Measure the pH of the solution using the calibrated pH meter.

### Alkalinity Source.

The composition preferably comprises a source of alkalinity. Preferably, the alkalinity source is selected from the group consisting of: silicate salt, such as sodium silicate, including sodium meta-silicate; source of carbonate such as sodium carbonate and potassium carbonate; source of hydroxide, such as potassium hydroxide and sodium hydroxide; and mixtures thereof.

### Source of Carbonate

Preferably, the composition comprises a source of carbonate. Preferably, the composition comprises a source of carbonate in an amount of 10 wt % or greater. Preferably, the composition comprises from 30 wt % to 70 wt % sodium carbonate.

### Enzyme System

Preferably, the composition comprises an enzyme system. Preferably, the enzyme system has protolytic activity, amylolytic activity and cellulolytic activity. Preferably, the composition comprises from 3 to 25 APU activity of protease, from 10 to 50 KNU activity of amylase and from 750 CEVU to 1,500 CEVU activity of cellulase.

### Method of Manufacture

The composition of the present invention can be made by any suitable method, including agglomeration, spray drying, or an extrusion process.

### Dosing Device

The dosing device is capable of being placed directly in the drum of an automatic washing machine. The dosing device is capable of dispensing the composition, or at least part thereof, directly into the drum of the automatic washing machine.

However, the dosing device is not a part of the automatic washing machine; as opposed to the dispensing draw, which is a part of the automatic washing machine. Instead, the dosing device is a physically autonomous entity (from the automatic washing machine), but is capable of being placed in the drum of the automatic washing machine

Suitable dosing devices may comprise a flexible bag mounted on a solid ring, such as those described in more detail in U.S. Pat. No. 4,969,927. The dosing device may also be a multi-compartment container, such as those described in more detail in U.S. Pat. No. 4,874,107. The dosing device may comprise a hollow body, an opening means for dosing of the solid detergent composition into the drum of the automatic washing machine and at least one or more elongated elements extending from the wall of the hollow body, such as those described in more detail in WO94/11562. Preferably, the dosing device is a granulette.

### EXAMPLES

### Examples 25-27

The following example compositions are solid free flowing granular laundry detergent compositions according to the present invention.

| | 25 | 26 | 27 |
|---|---|---|---|
| Ingredient | (wt %) | (wt %) | (wt %) |
| Sodium carbonate | 66 | 66 | 80 |
| C₈-C₁₈ alkyl ethoxylated alcohol having an | 1.1 | 1.1 | 1 |
| average degree of ethoxylation of 7 | | | |
| Alkyl polyglucoside | 10 | 10 | 9 |
| Quaternary ammonium cationic detersive | 1.1 | 1.1 | 1.4 |
| surfactant | | | |
| A compound having the following general | 1.7 | 1.7 | 1.2 |
| structure: bis((C₂H₅O)(C₂H₄O)n)(CH₃)—N⁺—CₓH₂ₓ—N⁺—(CH₃)- | | | |
| bis((C₂H₅O)(C₂H₄O)n), | | | |
| wherein n = | | | |
| from 20 to 30, and x = from 3 to 8, or sulphated | | | |
| or sulphonated variants thereof | | | |
| 1-hydroxy ethane-1, 1-diphosphonic acid (HEDP) | 0.4 | 0.4 | 0.8 |
| Silicone suds suppressor | 0.08 | 0.08 | 0.08 |
| Protease | 0.2 | | 0.2 |
| Amylase | 0.5 | | 0.3 |
| Mannanase | 0.3 | | 0.3 |
| Cellulase | 0.6 | | 0.3 |
| Reactive dye of examples 1-24 | 1.1 | 1.1 | 0.6 |
| Miscellaneous and moisture | to 100 wt % | to 100 wt % | to 100 wt % |

### Example 28

A suitable amount of any of compositions 25-27 is placed inside a dosing device, such as one described in U.S. Pat. No. 4,874,107, U.S. Pat. No. 4,969,927 or WO94/11562. The dosing device is then placed directly into the drum of an automatic washing machine, along with fabric to be treated. The fabric is treated using any of the automatic programs of the automatic washing machine.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A kit of parts for treating fabric in an automatic washing machine, the kit of parts comprising:
(a) a solid laundry detergent composition comprising a reactive azo dye; and
(b) a dosing device that is capable of being placed in the drum of the automatic washing machine.

2. A kit of parts according to claim 1, wherein the dye comprises a mixture of a reactive black 5 dye and at least one another reactive dye selected from the group consisting of red, orange and yellow reactive azo dye.

3. A kit of parts according to claim 1, wherein upon contact with water the composition has an equilibrium pH in the range of from 10.5 to 12.0 at a concentration of 4 g/l in de-ionized water and at a temperature of 20° C.

4. A kit of parts according to claim 1, wherein the composition comprises an alkalinity source selected from the group consisting of: silicate salt, such as sodium silicate, including sodium meta-silicate; source of carbonate such as sodium carbonate and potassium carbonate; source of hydroxide, such as potassium hydroxide and sodium hydroxide; and mixtures thereof.

5. A kit of parts according to claim 1, wherein the composition comprises from 30 wt % to 70 wt % sodium carbonate.

6. A kit of parts according to claim 1, wherein upon contact with water the composition has an equilibrium pH of 10.5 or greater at a concentration of 4 g/l in de-ionized water and at a temperature of 20° C.

7. A kit of parts according to claim 1, wherein the composition comprises a predominantly C₁₆ alkyl ethoxylated alcohol having an average degree of ethoxylation of from 3 to 7.

8. A kit of parts according to claim 1, wherein the composition comprises an alkyl polyglucoside.

9. A kit of parts according to claim 1, wherein the composition comprises a non-ionic detersive surfactant in particulate form, and wherein the particle has a cake strength of from 0 kg to 1.5 kg.

10. A kit of parts according to claim 1, wherein the composition is essentially free of anionic detersive surfactant.

11. A kit of parts according to claim 1, wherein the composition is essentially free of sodium sulphate.

12. A kit of parts according to claim 1, wherein the composition is essentially free of bleach.

13. A kit of parts according to claim 1, wherein the composition is essentially free of phosphate builder.

14. A kit of parts according to claim 1, wherein the composition is essentially free of zeolite builder.

15. A kit of parts according to claim 1, wherein the composition is essentially free of sodium silicate.

16. A kit of parts according to claim 1, wherein, the composition comprises from 3 to 25 APU activity of protease, from 10 to 50 KNU activity of amylase and from 750 CEVU to 1,500 CEVU activity of cellulase.

17. A kit of parts according to claim 1, wherein the dosing device is a multi-compartment container.

18. A kit of parts according to claim 1, wherein the dosing device is a granulette.

19. A kit of parts according to claim 1, wherein the dosing device comprises a hollow body, an opening means for dosing of the solid detergent composition into the drum of the automatic washing machine and at least one or more elongated elements extending from the wall of the hollow body.

20. A method of treating fabric comprising the steps of:
(a) contacting a fabric treatment composition as defined in claim 1 with a dosing device as defined in claim 1, to form an at least partially full dosing device;
(b) placing the at least partially full dosing device into the drum of an automatic washing machine; and
(c) treating fabric using the automatic washing machine.
